(19) United States
(12) Patent Application Publication
(10) Pub. No.: US 2012/0130074 A1
(43) Pub. Date: May 24, 2012

(54) Method for Preparation Metal Compounds of 8-Hydroxyquinoline or Derivatives

(76) Inventors: Lei Dai, Beijing (CN); Lifei Cai, Beijing (CN); Hongyu Zhao, Beijing (CN)

(21) Appl. No.: 13/264,070

(22) PCT Filed: Mar. 30, 2010
(86) PCT No.: PCT/CN2010/071409

§ 371 Date: Feb. 8, 2012

(30) Foreign Application Priority Data
Apr. 13, 2009 (CN) 200910081846.1

(51) Int. Cl. C07F 5/06; C07F 1/02

(52) U.S. Cl. 546/10; 546/179

(57) ABSTRACT

This invention, which involves “the preparation method of 8-hydroxyquinoline metallic compound”, is a synthetic method of organic electroluminescent materials. The preparation method of compound Mqnqm′ is to add solution prepared by Zengshui solvent and industrial ligand into reaction vessel, stir it at a certain temperature, and then achieve high-purity product, as for the Mqnqm′, M stands for Al, Li, n stands for 1-3, m is 0-2, q is 8-hydroxyquinoline and its derivatives, and q′ is ligand different from q. Zengshui solvent is adopted in this invention which can react effectively and thus reducing reaction time and avoiding cumbersome operation and the refining process; this invention also increases total yield and purity, the mother liquor obtained can be recycled, which reduces environment pollution and cost as well. This technology can also spread to the preparation of other 8-hydroxyquinoline metallic compound and the product achieved can be used as electroluminescent materials or electron-transport materials.

### TECHNICAL FIELD

This invention involves synthetic method of organic electroluminescent materials and preparation method of a high-purity 8-hydroxyquinoline metallic compound (Al, Li) in particular.

### TECHNICAL BACKGROUND

In 1987, Deng Qingyun of Kodak Company in the US successfully worked out sandwich-type double-layer light-emitting devices by using Alq3 as luminescent layer and aromatic diamines as hole transport layer (Tang C. W., et al. Applied Physics Letters, 1987, 51, 913). In 1990, Burroughes J. H. et al of Cambridge University developed organic polymer light-emitting diodes (Burroughes J. H., et al. Nature, 1990, 347, 5395). These major breakthroughs pushed development of organic light emitting technology significantly. Since that, scientists of various countries devoted much energy to research and development of this technology, consequently, an increasing number of organic electroluminescent materials have been developed and applied, and among which 8-hydroxyquinoline metallic compound is the most widely applied one due to its characteristics of good film formation, high efficiency, high brightness, excellent electronic transmission speed, high glass temperature, and simple synthesis procedure.

8-hydroxyquinoline aluminum, 8-hydroxyquinoline lithium, and (2-Methyl-8-hydroxyquinoline)-biphenoxy-Aluminium are currently the most widely used three 8-hydroxyquinoline metallic compounds, and have become very promising electronic transmission materials among organic light emitting materials due to their wide application in various electroluminescent devices, the performance of these devices has been improved accordingly (Liu zugang, et al. Synthetic Metals, 2002, 128, 221). However, in the preparation process of organic electroluminescent devices, trace of impurities is very likely to cause pinholes, short circuit and black point, thereby affecting life of the device, so it is crucial to prepare high purity material. In the existing synthetic methods, some is backward and the product obtained may contain solvent molecules, which seriously affects brightness and efficiency of devices (Kim T.-S., et al, Science and Technology of Advanced Materials, 04, 5, 331); some produce products with impurities of luminescence quenching, which also has a serious impact on life of devices (Papadimitrakopoulos F., Zhang X. M., Synthetic Metals, 1997, 85, 1221) and the production time is long as well; and some of the raw materials needed in other synthetic methods are hard to obtain, such as aluminum triethyl, or the reaction is too violent and some impurities which are hard to remove occurred during preparation (Wang guang, et al, Synthetic Metals, 2002, 131, 1-5). All of these bring tremendous difficulties to wide application of materials and industrial production. Therefore, it is urgent to find a method that could effectively synthesize 8-hydroxyquinoline metallic compound, and meanwhile avoid defects of current synthesis methods.

### INTRODUCTION OF THIS INVENTION

Aiming at problems existed in current synthetic methods, this invention mainly solves problems of low yield, many side reactions and long production cycle of 8-hydroxyquinoline. By improving reaction conditions, this invention can control ongoing reaction and obtain single-ligand metal complexes, as well as metal complexes of different ligands. No protic solvent or solvent that easily causes coordination are used in reaction, thus side reaction is avoided and yield and purity are enhanced, mother liquor of the reaction can be recycled and used directly, which can lower cost.

The preparation method of compound Mqnqm′ includes the following procedures, and in the compound, M stands for Al, Li, n for 1-3, m for 0-2, q is 8-hydroxyquinoline and its derivatives, and q′ is ligand different from q.

(1) Preparation of raw materials for production: add Zengshui solvent I to aluminum alkoxy or lithium compound to obtain A; add q solvent to Zengshui solvent II to get B; add q′ which is different from q to Zengshui solvent III to get C in which the number of carbon atoms in alkoxy of the aluminum alkoxy is 3-6;

(2) reaction: in the atmosphere of nitrogen, add B and C to A respectively, the reaction temperature is 25° C.-140° C.

The stated reaction temperature should be 25° C.-120° C.

The stated Zengshui solvent I, II, III are one of toluene, xylene, petroleum ether, or halogenated hydrocarbon solvent respectively.

When M stands for aluminum, the stated Zengshui solvent I, II, III are toluene and xylene; when M stands for lithium, Zengshui solvent I, II, III are methylene chloride and chloroform.

The stated Zengshui solvent I, II, III are the same solvent.

The aluminum alkoxy mentioned above is aluminum isopropoxide.

The inorganic lithium mentioned is lithium hydroxide hydrate or lithium hydroxide.

The stated method also includes separation procedure of Mqnqm′, which consists of filtering the liquid reactant, washing and drying the filtered material.

The mentioned drying method is vacuum drying at the temperature of 50° C.-250° C.

The stated q′ is phenol and its derivatives, xenol or 8-hydroxyquinoline derivative different from q.

All raw materials participated in reaction are dissolved in Zengshui solvent (the organic solvent which is immiscible with water), and react under the condition of nitrogen and with raw materials dropped in it. The adopted solvent and raw materials can be used directly without any special treatment, but the synthesis laboratory, drying process and preservation environment should maintain sour gas free. Since aluminum compounds are organic and lithium compounds are inorganic, only aluminum compounds dissolve in Zengshui solvent I. For convenient recycle of solvent, it is better to use the same one as raw material solvent. When dissolving 8-hydroxyquinoline compounds in solvent, the amount of solvent needed is determined by solubility of compounds; add solvent if large crystal is wanted; if the compound is ligand-dislocated, then dissolve compounds with different ligands separately. The temperature of above reaction should be controlled at 25° C.-120° C., and product precipitation will be seen quickly, after add all solvent and stir till no product precipitation appears, isolate the target product through filtration, wash the target products with solvent and dry them, then product with over 99% purity is obtained. Compared with the method in literatures, yield gained through this method increases significantly.

Metallic compound obtained through the above technique solves the current problems of low yield and many side reactions, and possesses the following merits:

(1) Zengshui solvent, instead of protic solvent or solvent that easily causes coordination, is adopted during the synthetic process, which avoids solvent molecules complex. As a result, the product obtained has no ligand solvent molecules and no pinholes appear during the device making process, and the brightness, efficiency and life of the device will not be affected as well.

(2) During the synthetic process, solvent and raw material used are industrial ones without any special treatment, which simplifies reaction procedures and the product gained can be directly used in luminescent devices.

(3) Byproduct obtained during the synthetic process is neutral, which prevents acid produced via former techniques as well as side reactions caused by the acid; moreover, no byproduct is created during sublimation and application of the product.

(4) No water is used during production and after-treatment process, which avoids the most harmful gravy and other ionic impurities brought by water, the synthesized 8-hydroxyquinoline metallic compound also contains no ionic impurities. In addition, during preparation of this invention, no waste water is generated, which causes zero environmental pollution.

(5) Apart from high yields, products gained through 8-hydroxyquinoline lithium are also stable compounds with no decomposition phenomenon during heating and sublimation.

(6) This technique not only applies to compound currently involved, but also other metal's 8-hydroxyquinoline compound and compound of other ligands.

### DESCRIPTION OF FIGURES

FIG. 1: MRI of Implementation Example 1 with no solvent peak.

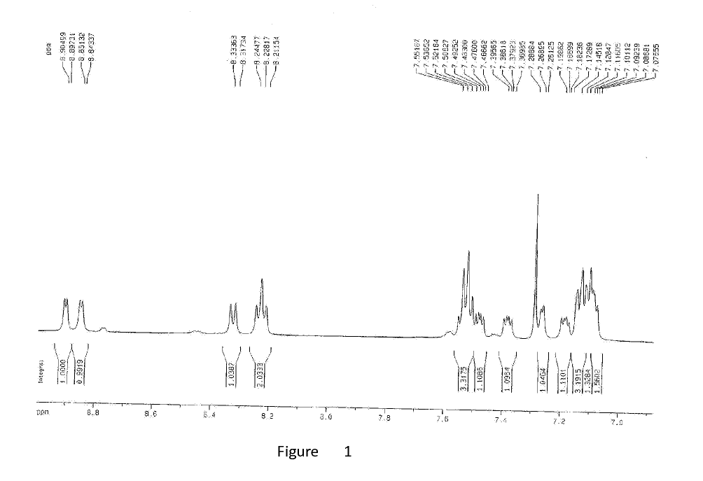

FIG. 2: MRI of Comparison Example 2 with solvent peak.

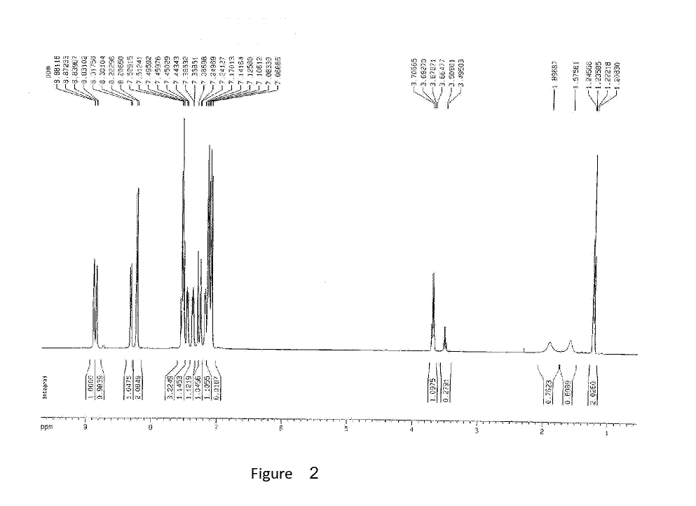

FIG. 3: MRI of Implementation Example 3.

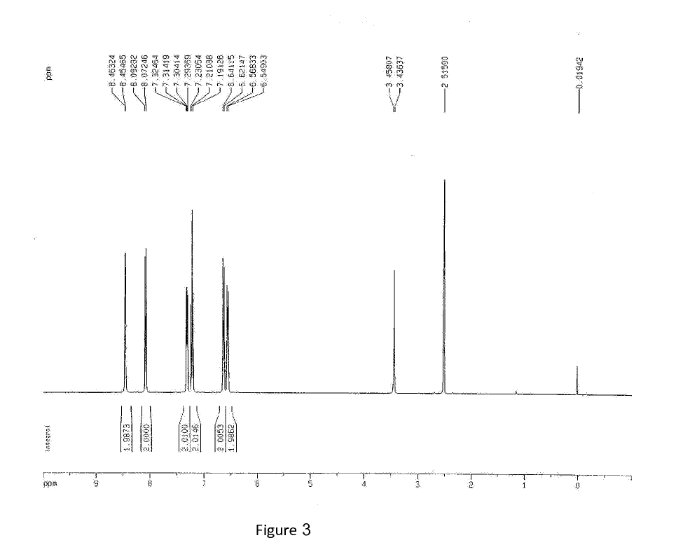

FIG. 4: MRI of Comparison Example 3.

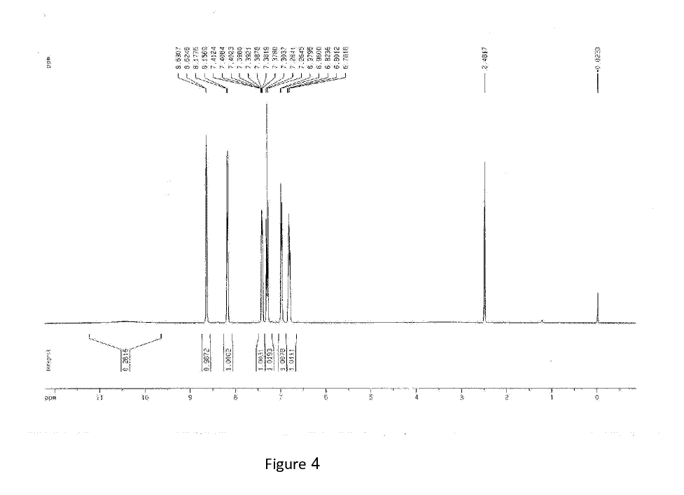

### PRACTICAL IMPLEMENTATION MEASURES

### Implementation Example 1

### Using Aluminum Isopropoxide as Raw Material to Synthesize 8-hydroxyquinoline aluminum

Add 120 ml toluene into four 500 ml boiling flask-4-neck, then put aluminum isopropoxide in the flasks, mixing with nitrogen and stirring until total dissolution and colorless and transparent liquid appears. Dissolve 8-hydroxyquinoline in 120 ml toluene through constant pressure dropping funnel, when start dropping, yellowish-green color appears immediately, and yellow sediments come out very quickly, after all 8-hydroxyquinoline solution is added, a large amount of sediments are produced. The temperature should maintain 60° C., and stop heating after 30 minutes of reaction, then cool it to room temperature, filtrate it, and a large amount of fibrous solids are obtained. Wash the solids twice with 150×2 ml toluene and 150×2 ml petroleum ether respectively, then vacuum drying them for 6 hours at 70° C., at last 17.5 g bright yellow products are obtained with yield of 95%.

### Comparison Example 1

### Using Aluminum Stearate as Raw Material to Synthesize 8-hydroxyquinoline aluminum. (Reference World Patent WO0125211)

Add 10 g aluminum stearate and 50 ml toluene into 500 ml boiling flask-4-neck, and then stir till the mixture is turbid. Drop 6.0 g 8-hydroxyquinoline solution into 150 ml toluene at room temperature, add nitrogen, then yellowish-green color appears immediately, a large amount of yellowish-green solids are produced with increasing input of 8-hydroxyquinoline. Rise the temperature and reflux for 24 hours, then cool and filtrate them, and flaky yellowish-green solids are obtained; wash them twice with toluene, then vacuum drying at 70° C., at last 5 g yellowish-green solids are obtained with yield of 79%.

### Comparison Example 2

### Using Aluminum Sulfate as Raw Material to Synthesize 8-hydroxyquinoline aluminum (Rare Metals, 2003, 24, 44-46)

Dissolve 20.22 g aluminum sulphate Al2 (SO₄)3.18H₂O in 11 boiling flask-4-neck, add 200 ml water and nitrogen to them, then raise temperature to 65° C. Drop 26.4 g 8-hydroxyquinoline into 400 ml ethyl alcohol, yellow sediments appear immediately, and at that time, the PH=5-6. As more 8-hydroxyquinoline is added, sediments also increase, and all 8-hydroxyquinoline is added in an hour. Buffer solution of ammonium acetate adjusts PH to 6.0-6.5, and after 30 minutes of reaction at 65° C., products of light green solids are obtained, then filtrate them twice with 100 ml ethyl alcohol, 100 ml water, 100 ml ethyl alcohol, and 100 ml ethylether respectively at room temperature, the products gained after these processes are still light green, dry them overnight at 70° C., the final products are 27.22 g with yield of 97.6%, but there is solvent peak in MRI.

### Implementation Example 2

### Synthesize bis(2-methyl-8-quinolinolato)-4-(phenoxyphenyl) Al

Add 4-xenol and 200 ml toluene in 1 L boiling flask-4-neck, and then fill in nitrogen and stir until all ingredients are dissolved. Drop aluminum isopropoxide into 120 ml toluene, white sediments appear immediately, all the aluminum isopropoxide is added in 1.5 hour, and then stir the mixture for an hour. Drop 2-methyl-8-hydroxyquinoline, yellowish-green sediments emerge immediately, reflux 16 hours after 1 hour when all the material is added. Then cool it, and yellowish solids are precipitated, filtrate the solids, white solids are gained. Purify the toluene, dry it, and the yield is 80%.

### Implementation Example 3

### Synthesize 8-hydroxyquinoline lithium

Add 120 ml methylene chloride in 250 ml boiling flask-4-neck; then add lithium hydroxide hydrate, and stir until white sediments appear. Within half minute after batch addition of 8-hydroxyquinoline, the mixture turns cream and the color becomes darker quickly, and after overnight reaction at 25° C., a large amount of yellow solids are obtained. Filtrate the yellow solids obtained; wash them twice with a total of 100 ml methylene chloride, and then dry them at 200° C. for 24 hours, the yield is 90%.

### Comparison Example 3

### Synthesize 8-hydroxyquinoline lithium (Reference Chinese Patent CN513940)

We repeat the procedures in Chinese Patent CN1513940 and the yield is 40%, but there are a large number of decomposition phenomena during heating and drying process.

### Implementation Example 4

### Aluminum, tris (4-methyl-8-quinolinolato-kN1, kO8)-

Synthesize aluminum, tris (4-methyl-8-quinolinolato-kN1, kO8)—in accordance with the method provided by Implementation Example 1, and yellow solid is obtained with yield of 70%.

1. The preparation method of compound Mqnqm′ includes the following procedures, and in the compound, M stands for Al, Li, n for 1-3, m for 0-2, q is 8-hydroxyquinoline and its derivatives, and q′ and q are different ligands.
1) Preparation of raw materials for production: add Zengshui solvent I to aluminum alkoxy or lithium compound to obtain A; add q solvent to Zengshui solvent II to get B; add q′ which is different from q to Zengshui solvent III to get C in which the number of carbon atoms in alkoxy of the aluminum alkoxy is 3-6; (2) reaction: in the atmosphere of nitrogen, add B and C to A respectively, the reaction temperature is 25° C.-140° C.

2. According to the preparation method in claim 1, the stated reaction temperature should be 25° C.-120° C.

3. According to the preparation method in claim 2, the stated Zengshui solvent I, II, III are one of toluene, xylene, petroleum ether, or halogenated hydrocarbon solvent respectively.

4. According to the preparation method in claim 3, when M stands for aluminum, the stated Zengshui solvent I, II, III are toluene and xylene; when M stands for lithium, Zengshui solvent I, II, III are methylene chloride and chloroform.

5. According to the preparation method in claim 4, the stated Zengshui solvent I, II, III are the same solvent.

6. According to the preparation method in claim 1, the aluminum alkoxy mentioned above is aluminum isopropoxide.

7. According to the preparation method in claim 1, the inorganic lithium mentioned is lithium hydroxide hydrate or lithium hydroxide.

8. According to the preparation method in claim 1, the stated method also includes separation procedure of Mqnqm′, which consists of filtering the liquid reactant, washing and drying the filtered material.

9. According to the preparation method in claim 7, the mentioned drying method is vacuum drying at the temperature of 50° C.-250° C.

10. According to any preparation method in claim 1-9, the stated q′ is phenol and its derivatives, xenol or 8-hydroxyquinoline derivative different from q.
